(19) United States
(12) Patent Application Publication
(10) Pub. No.: US 2001/0027706 A1
(43) Pub. Date: Oct. 11, 2001

(54) Numerical controlled machine having a micro-fog collecting apparatus

(75) Inventor: Takayuki Shimizu, Shizuoka-ken (JP)

Correspondence Address: BURGESS, RYAN AND WAYNE, Suite 2105, 370 Lexington Avenue, New York, NY, 10017, US

(73) Assignee: Heian Corporation

(21) Appl. No.: 09/825,729

(22) Filed: Apr. 4, 2001

(30) Foreign Application Priority Data
Apr. 7, 2000 (JP) 2000-105963

(51) Int. Cl. B23B 7/00; B23B 9/00

(52) U.S. Cl. 82/118; 82/147

(57) ABSTRACT

A processing machine wherein oil micro-fog is supplied to an upper bearing and a lower bearing of a rotary shaft of a head through a supply pipe from an oil micro-fog supply device. The upper bearing is isolated from the atmosphere by a bearing cover and the lower bearing is isolated from the atmosphere by an isolator. The oil micro-fog supply to the upper bearing and the lower bearing is collected by a collecting pipe, a collecting passage of the head and a collector.

### FIELD OF THE INVENTION

The present invention relates to an oil micro-fog oiling apparatus for a processing machine and particularly, a numerical controlled machine in which an oil micro-fog is applied to and is collected from bearings of a head of the numerical controlled machine.

### BACKGROUND OF THE INVENTION

In a numerical controlled router in the prior art, a head structure is mounted to move along a front side of a cross-beam in an upper portion of a base member. A plurality of heads are mounted to move on the front side of the head structure. A table is provided under the head structure, a process board is positioned on the table, the table is moved back and forth under the cross beam or the table is fixed and the cross beam is moved back and forth across the table.

An oil micro-fog generating device is respectively connected through supply pipes to the heads mounted on the head structure.

The head comprises a support member to which a stator of a motor is fixed; a rotor adjacent to the stator is mounted on a rotary shaft and the rotary shaft is supported by an upper bearing supported by an upper support member and a lower bearing supported by a lower support member. A tool holder, for holding a tool, is provided at a lower end of the rotary shaft. A tool is mounted on the tool holder. A brush for controlling scatter of cutting debris can be provided at the lower end of the support member and the rotary shaft rotates when electric power is supplied to the stator.

A pipe is connected to the head by a connector to a supply passage of the support member of the head. An oil micro-fog is supplied to the supply passage through the pipe and is applied to the upper bearing through an upper supply passage of the upper support member and is applied to the lower bearing through a lower supply passage of the lower support member.

In such a processing machine which is numerically or digitally controlled, in one embodiment, the process board is positioned on the table, and the head structure is programmed to move along the cross beam. The table is programmed to move back and forth, the tool is rotated by the rotating rotary shaft of a head. The tool is moved vertically and the process board on the table is processed by the tool.

However, in the above numerical controlled machine, the upper bearing and the lower bearing are open to the atmosphere. The oil micro-fog supplied through the upper supply passage to the upper bearing and through the lower supply passage to the lower bearing is discharged to the atmosphere from the upper bearing and the lower bearing.

In the numerical controlled machine, air is supplied to the upper portion of the head and passes to the upper bearing and then passes between the stator and the rotor, the lower bearing and the periphery of the lower end of the rotary shaft and is discharged from the inside of the brush to the atmosphere so that wood chips are prevented from entering the lower bearing.

Because the oil micro-fog is discharged with the air when the air is discharged from the head, the atmosphere in a factory is polluted by the oil micro-fog. It is unhealthy for the factory workers to breathe the oil micro-fog. Further, because the oil micro-fog is easy to ignite, factory workers must be careful of fire.

Numerically or digitally controlled processing machines are well known in the art. The movements of the components of the machine are controlled by a computer or digital control device which controls movement of the components to provide a machined or processed substrate having a required shape. The numerical or digital controls are well known in the art and will not be discussed further here.

### BRIEF SUMMARY OF THE INVENTION

It is, therefore, the primary object of the present invention to provide an apparatus for distributing and collecting oil micro-fog in a numerical controlled processing machine in which an upper bearing and a lower bearing are isolated from the atmosphere.

It is another object of the present invention to provide an apparatus for collecting oil micro-fog in a numerical controlled processed machine in which a cover is arranged above the upper bearing to isolate the upper bearing from the atmosphere. It is another object of the present invention to provide an apparatus for collecting oil micro-fog in a numerical controlled processing machine in which an isolator is arranged below the lower bearing for isolating the lower bearing from the atmosphere.

In order to accomplish the above and other objects, the present invention is directed to a numerically controlled processing machine comprising a head having a motor comprising a stator provided with a support member; a rotor arranged on a rotary shaft; an upper bearing and a lower bearing for supporting the rotary shaft; a tool holder for holding a tool arranged at an end of the rotary shaft; means for respectively isolating the upper bearing and the lower bearing from the atmosphere; an oil micro-fog supply apparatus for supplying oil micro-fog to the upper bearing and the lower bearing; and a collection apparatus for collecting the oil micro-fog supplied to the upper bearing and the lower bearing.

### BRIEF DESCRIPTION OF THE INVENTION

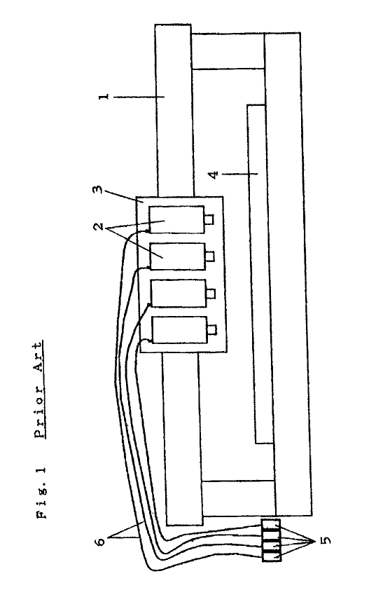

FIG. 1 is a schematic representation of a numerical controlled machine having an oil micro-fog supply apparatus of the prior art.

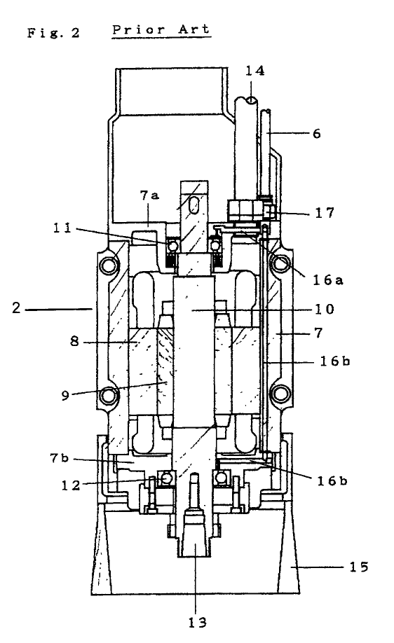

FIG. 2 is a sectional view of a head of the numerical controlled machine of FIG. 1.

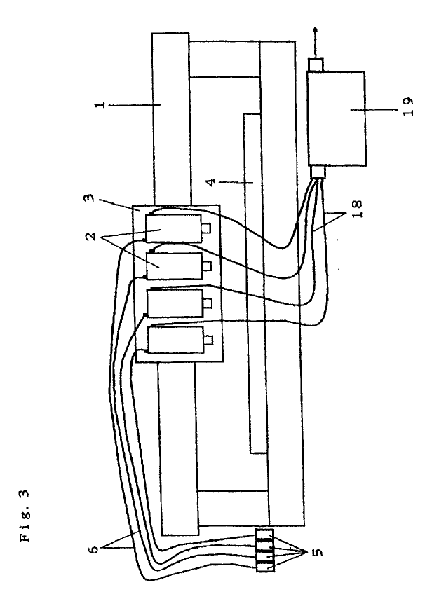

FIG. 3 is a schematic representation of a numerical controlled machine having an oil micro-fog supply apparatus of the present invention.

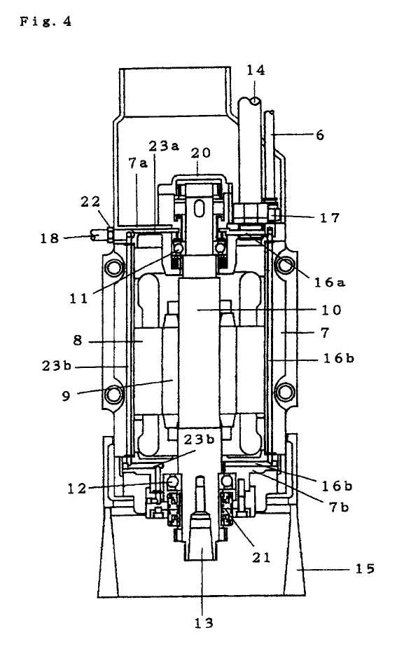

FIG. 4 is a sectional view of a head of the numerical controlled machine in FIG. 3.

### DESCRIPTION OF THE PREFERRED EMBODIMENTS

As used herein, the term processing machine refers to a machine for cutting, shaping, routing, milling, drilling, grinding or machining a solid with a rotating tool. The machine is preferably numerically controlled. The inventive feature resides in reducing the amount of a lubricating oil micro-fog which enters the atmosphere from lubrication of the machine by isolating the oiled bearings and collecting the oil micro-fog.

As used herein, the term “isolated” refers to separating the bearings or bearing chambers from the atmosphere by a path which provides a resistance to flow of the micro-fog from the bearing chamber to the atmosphere. The term “isolation” does not imply that the bearing or bearing chambers are hermetically sealed or completely separated from the atmosphere but only that a path for flow of the oil micro-fog from the bearing chamber to the atmosphere provide an impedance to the flow.

In a numerical controlled machine in the prior art, the head structure 3 having a plurality of heads 2 is mounted to move along a cross beam 1 as shown in FIG. 1. A table 4 in which a process board is positioned is provided under the cross beam 1. The table 4 or the cross beam is moved back and forth, and an oil micro-fog supply device 5 is connected through supply pipes 6 to the heads 2.

As shown in FIG. 2, a stator 8 of a motor is attached to a support member 7 of the head 2; a rotor 9 is attached to the rotary shaft 10 adjacent to the stator 8. The rotary shaft 10 is supported by an upper bearing 11 supported by an upper support member 7a and the lower bearing 12 supported by a lower support member 7b. A tool holder 13, for holding a tool, is arranged at the lower end of the rotary shaft 10; a brush 15 is attached to the lower end of the support member 7. A cable 14 for supplying electric power to the motor is attached to the upper portion of the head 2.

An oil micro-fog supply pipe 6 is connected to the support member 7 by connecting member 17; the oil micro-fog is supplied to the upper bearing 11 through a supply passage 16a formed in the upper support member 17a and to the lower bearing 12 through a supply passage 16b formed in support member 7 and the lower support member 7b.

In such a numerical controlled router, a process board is positioned on the table 4; the head structure is moved along the cross beam 1, the head is moved up and down vertically, the table 4 or the cross beam 1 is moved back and forth, the tool is rotated by rotation of the rotary shaft 10 of the head 2, and the process board on the table is processed by the tool according to a program in the numerical controlled router.

In this numerical controlled machine, the oil micro-fog supplied to the supply passages 16a and 16b, is discharged from the upper bearing 11 and the lower bearing 12 to the atmosphere. Since the upper bearing 11 and the lower bearing 12 are open to the atmosphere, compressed air supplied to the upper end of the head 2 is discharged through the brush at the lower end of head 2 to prevent wood chips from entering the lower bearing 12. The oil micro-fog supplied to the upper bearing 11 and the lower bearing 12 is discharged to the atmosphere with the compressed air supply to the head 2. The atmosphere in the factory is polluted by the oil micro-fog and has a bad health effect on the factory workers breathing air containing the oil micro-fog. Because the oil micro-fog is easy to ignite, factory workers must be careful of fire.

Referring to FIGS. 3 and 4, which schematically illustrate a numerical controlled processing machine of the invention, 1 designates a cross beam; 2, a head; 3, a head structure; 4, a table; 5, an oil micro-fog supply device; 6, conduits for carrying the oil micro-fog; 7, a support member; 8, a stator of a motor; 9, a rotor of a motor; 10, a rotary shaft; 11, an upper bearing; 12, a lower bearing; 13, a tool holder; 14, an electric cable; 15, a brush; 16a and 16b, designate supply passages; and 17 designates a connecting member. Since these structures are the same as the above prior art, explanation of these structures is omitted.

In the embodiment of the present invention, as shown in FIG. 3, one end of collecting pipes 18 is respectively connected to each head 2 and the other end is connected to a collecting device 19. A bearing cover 20 is arranged above the upper end of rotary shaft 10 above the upper bearing 11. An isolator 21 is arranged at the periphery of the rotary shaft 10 below the lower bearing 12. A connecting member 22 for connecting the collecting pipe 18 to the head is arranged at the upper end of the support member 7, a collecting passage 23a for collecting the oil micro-fog from the upper bearing 11 is formed in the upper support member 7a for connecting to the connecting member 22. A collecting passage 23b is formed in the support member 7 and lower support member 7b for collecting the oil micro-fog from the lower bearing 12.

In this apparatus which comprises a collector for oil micro-fog in the present embodiment, the rotary shaft 10 of head 2 is supported by the upper bearing 11 isolated from the atmosphere by bearing cover 20 and the lower bearing 12 is isolated from the atmosphere by the isolator 21. Therefore, because the oil micro-fog supply to the upper bearing 11 and the lower bearing 12 is collected through the collecting passages 23a and 23b and the collecting pipes 18 by the collecting device 19, the amount of oil micro-fog discharged from the head 2 to the atmosphere in a factory is substantially reduced. Thus, the air pollution in the factory by the oil micro-fog is substantially reduced or eliminated and the health of the factory workers is not harmed by breathing oil micro-fog and the danger of fire is lowered.

In the above description, the embodiment illustrates four heads 2 mounted on the head structure 3 and is explained. The number of heads 2 mounted on the head structure 3 may be 1 to 4 or more and each head is connected to the oil micro-fog supply device 5 and the oil micro-fog collected device 19 through the pipes.

As stated above, in the apparatus comprising a device for collecting oil micro-fog in a numerical controlled processing machine, the upper bearing is isolated from the atmosphere by a bearing cover, the lower bearing is isolated from the atmosphere by an isolator, the oil micro-fog supplied to the upper bearing and the lower bearing is collected through the collecting passage and the collecting pipes by the collecting device. Therefore, because the oil micro-fog is not discharged from the head to the atmosphere, the pollution of the atmosphere in a factory by the oil micro-fog is substantially reduced. Thus the health of the factory workers is improved by not breathing the micro-fog and also the risk of fire is substantially reduced.

The numerical controlled processing machine of the invention controls the emission of oil micro-fog from the processing machine by isolating the motor support bearings from direct contact with the atmosphere and providing a collecting apparatus to collect the oil micro-fog. Preferably, the oil micro-fog is disposed of in an environmentally friendly manner. An isolator of the type disclosed in U.S. Pat. No. 5,069,461 can be used in the apparatus of the invention. The contents of the aforesaid U.S. patent are incorporated herein by reference. The preferred isolator of this type is the INPRO/SEAL manufactured by______.

As shown, the upper bearing is isolated by providing a bearing cap above the chamber in which the bearing is mounted. However, isolation can be achieved by a bearing seal or isolator above the bearing or other means which prevents the oil micro-fog from escaping to the atmosphere from the bearing chamber. A labyrinth seal or an isolator can be useful. Generally, the bearing is isolated from the atmosphere by providing a means which impedes the flow of the oil micro-fog directly from the bearing compartment or housing to the atmosphere. The impediment of flow does not require a vapor tight housing but can utilize a housing with a flow path to the atmosphere which provides resistance to the escape of the oil micro-fog or the entry of outside air coupled with a collection device which collects the oil micro-fog.

It is advantageous to maintain the bearings at a pressure of atmospheric and higher to provide protection from intrusion of machining debris into the bearings.

The apparatus for collecting the oil micro-fog generally comprises means such as conduits for connecting the collection device to a bearing chamber which is isolated. Means can also be provided for disposing of the oil micro-fog in a preferably environmentally friendly manner.

The collector can also comprise an incinerator to burn the oil micro-fog, and such an incinerator can be catalytic, non-catalytic or a combination of catalytic and non-catalytic filters, impingement devices, contactors, scrubbers, electrostatic precipitators, agglomerators, settling chambers, collectors and the like for causing small oil droplets to separate from a gas stream. The collectors are known devices which have been used in other apparatus for collecting and optionally separating small particles from a gas stream.

The present invention has been described in relation to a numerically controlled or digitally controlled router. However, the present invention is applicable to other processing machining devices which use rotating tools to shape metal, wood, plastics, composites and other solid materials. The machining device does not have to be numerically controlled so long as the machine utilizes an oil micro-fog to lubricate bearings on a head which carries rotating, cutting, or shaping tools.

The invention is applicable to a device which comes on a head as long as an oil micro-fog is utilized to lubricate the bearings on a head carrying a rotating cutting tool.

What is claimed is:

1. A numerically controlled processing machine comprising a head having a motor comprising a stator provided with a support member; a rotor arranged on a rotary shaft; an upper bearing and a lower bearing for supporting the rotary shaft; a tool holder for holding a tool arranged at an end of the rotary shaft; the upper bearing and the lower bearing being isolated from the atmosphere; an oil micro-fog supply apparatus for supplying oil micro-fog to the upper bearing and the lower bearing, a collection apparatus for collecting the oil micro-fog supplied to the upper bearing and the lower bearing and a numerically controlling device to control operation of the machine.

2. The processing machine router as set forth in claim 1 wherein the upper bearing is isolated by a bearing cover over an upper portion of the rotary shaft.

3. The processing machine as set forth in claim 1 wherein the lower bearing is isolated from the atmosphere by an isolator in contact with a lower portion of the rotary shaft below the lower bearing.

4. The processing machine as set forth in claim 1 wherein the supply and collection of the oil micro-fog to the upper bearing and the lower bearing is effected by passages formed in the upper support member, the support member and the lower support member.

5. The processing machine as set forth in claim 1 wherein at least one head is mounted on the head structure.

6. A numerical controlled router comprising a head having a stator attached to a support member; a rotary shaft for carrying a rotor opposite to the stator; an upper bearing for supporting the rotary shaft which is isolated from the atmosphere by a bearing cover arranged to cover an upper portion of the rotary shaft; a lower bearing for supporting the rotary shaft which is isolated from the atmosphere by an isolator arranged to contact the lower portion of the rotary shaft; a supply passage for an oil micro-fog and a collecting passage for the oil micro-fog comprising passages arranged in cooperation with the upper support member, the support member and the lower support member; a supply pipe arranged to be connected to the supply passage at the upper support member; a collecting pipe arranged to be connected to the collecting passage; an oil micro-fog supply device for supplying oil micro-fog to the upper bearing and the lower bearing through the supply pipes; and a collecting device for collecting the oil micro-fog supplied to the upper bearing and the lower bearing through the collecting pipe and a numerically controlling device to control operation of the router.

7. The router of claim 6 wherein at least one of the upper and the lower bearings is maintained at a pressure not lower than atmospheric pressure.

8. The processing machine of claim 1 wherein at least one of the upper bearings and the lower bearings is maintained at a pressure not lower than atmospheric pressure.

9. The processing machine of claim 1 wherein the machine includes a plurality of heads.

10. The processing machine of claim 9 wherein the machine is a router.

11. The processing machine of claim 1, wherein the machine is a router.

12. The processing machine of claim 1 wherein the machine is arranged for cutting or shaping at least one member selected from the group consisting of wood, metal, plastic and composites.

13. The processing machine of claim 9 wherein the machine is arranged for cutting or shaping at least one member selected from the group consisting of wood, metals, plastic and composites.
